(19) United States
(12) Patent Application Publication
(10) Pub. No.: US 2009/0313879 A1
(43) Pub. Date: Dec. 24, 2009

(54) MOUSE TRAP

(76) Inventor: Khymych Vasyl, Brooklyn, NY (US)

Correspondence Address: Konstantin Goriachi, 111 Broadway, Suite 1306, New York, NY, 10006, US

(21) Appl. No.: 12/145,449

(22) Filed: Jun. 24, 2008

(51) Int. Cl. A01M 23/34

(52) U.S. Cl. 43/87; 43/85

(57) ABSTRACT

The trap consists of a prism-shaped main body (1); 8-shaped jaw membrane (2), see FIG. 6, made out of a single piece of metal wire and loosely attached to a J-shaped spring (3), also made out of a single piece of metal wire; threat (5) that connects the spring with the drum and the arrester that prevents the mouse from backing;

Main body represents a right square prism bearing a circular opening situated symmetrically in its base (B), which leads to a cylindrical hole (7). Said hole continues into the body longitudinally, three forth of the prism length along axel Z. Bait is set at the deep end of the hole (7). The wire that shapes the J-shaped spring is formed into a larger ring at its one end, forming the spring, as shown on FIG. 6.

### BACKGROUND OF THE INVENTION

There are three prior arts that are relevant to the invention at hand. First is patented to Abraham G. Schwartz under U.S. Pat. No. 1,899,641 in February of 1933. Second, to Antoni Locaj, under U.S. Pat. No. 1,323,400. Both invention, similar to that at hand, also offered choking traps based on the spring powered mechanism. They also incorporated main body in a shape of a square prism, and a choking membrane (choker loop), which in its released position would trap the mouse by holding it inside the device with the choker loop pooling it upwards and squeezing against the ceiling of the inside camera of the device. The invention at hand, however, is totally different in many respects. First, unlike in the prior arts, the main body here though shaped as prism, is not hollow prism with the inside camera for the mouse to enter, but a solid prism with a relatively small hole in it sufficient to accommodate a head and part of a body of a mouse. In the prior arts mouse must enter the devise fully and reach the bait to trigger the spring release. Here, mouse only can stick in its head and maybe part of the body, in one direction,—toward the bait. Second, in both prior arts, the bait is secured at the end of the hook, incorporated into the spring mechanism. The spring is released when mouse touch the hook, thus moving it from a secure position to a loose one. Here, bait is inserted at the end of the cylindrical hole in the main body, and separated from the mouse by a thread which stands in its way as the mouse goes for the bait. To reach the bait mouse needs to crunch the thread off, thus setting the spring loose as the threat secures the spring in cocked position. The mouse may never even touch the bait. Third, as in the prior arts, the bait is secured at the end of the hook, there is very limited type of food to be used, as only soft food can be pinned on the hook. Here, any food can be used, as it lies freely at the end of the hole, inside the device and must be attached nowhere. Fourth, the prior arts consist of a large number of parts, assembled in a very peculiar way, making it rather complex for manufacturing and assembling. Here, number of parts is small, and all of them are reachable, requiring little effort for assembling and charging the device. Finally, the release mechanism in both prior arts is also unstable as the spring in charged position is only secured by a proper position of the hook. This fact makes the mechanism amenable to be triggered by any movement not exclusively that of a mouse, making it hard to charge in any surface but flat, or prevent the mechanism to be moved in cocked position. Here, the device can be easily moved while in a cocked position, as the threat secures the spring when cocked and can only be released with the structural damage to the threat sufficient to be overcome by the force of the spring, like a bite of a mouse.

Third invention was patented to Mr. Johann Koranicki under U.S. Pat. No. 1,496,421 in 1922. Like the invention at hand, its main body is made of a solid material, but it is not shaped as a prism, but as a round cylindrical cone. The opening inside the cone is big enough for the mouse to fully enter and maneuver inside. Like other prior arts, it is powered by a spring mechanism and triggered by a mouse touching a hook inserted inside the main body, to which hook bait is attached. Mouse eats the bait, moves the hook, which movement triggers the spring release. As spring is released it pools the choking ring, which traps the mouse by pulling it upward and squeezing against the top of the inside cylindrical camera of the device. Like in other prior arts the mouse needs to enter the device fully and move the hook from its secure position to trigger the device. In addition, to all the differences described above relative to other prior arts, which apply here too, this device is unstable also because it can roll over as the mouse moves inside, potentially giving the mouse opportunity to escape.

### SUMMARY OF THE INVENTION

The given invention represents an innovating way of trapping mice as it utilizes the power of a spring to hold the mouse in a preset hole inside which it is drawn by the smell of bait. Once trapped, the mouse is held stuck inside the hole by the ring attached to the spring with a negligible opportunity to escape. It differs from any existing mouse traps in several important ways. First, its assembly presents very simple construction consisting only of five parts simplifying its operation. A mouse, having been attracted by the smell of bait placed at the inner end of the hole, enters the hole with two thirds of it body in, at which point it meets a threat that prevents the mouse from reaching the bait. The mouse bites the thread loose in order to reach the bait. As the threat that holds the J-shaped spring from retracting, is bitten loose, the spring is released into action, which lifts the 8-shaped membrane up and in so doing traps the mouse by pressing its body against the ceiling of the hole, thus bringing mouse's ability to move to a full halt. The mouse trap is safe even for children to use because there are no dangerous fast-snapping springs or spirals, which can cause injury. Second advantage of this mouse trap is that once the mouse is caught, it can be easily released while a person does not even nave to come in contact with the mouse. Since two thirds of the mouse's body is inside the device, the only operation needed to be performed for releasing the mouse is lowering the 8-shaped membrane and in so doing releasing the pressure of the spring that holds the mouse. The invention is also easy to carry and store due to its small size and lack of health hazards similar to those its existing counterparts present to people.

### BRIEF DESCRIPTION OF THE DRAWING(S)

The figures of the drawing are briefly described as follows:

FIG. 1 is a side view of the present invention in the uncocked position;

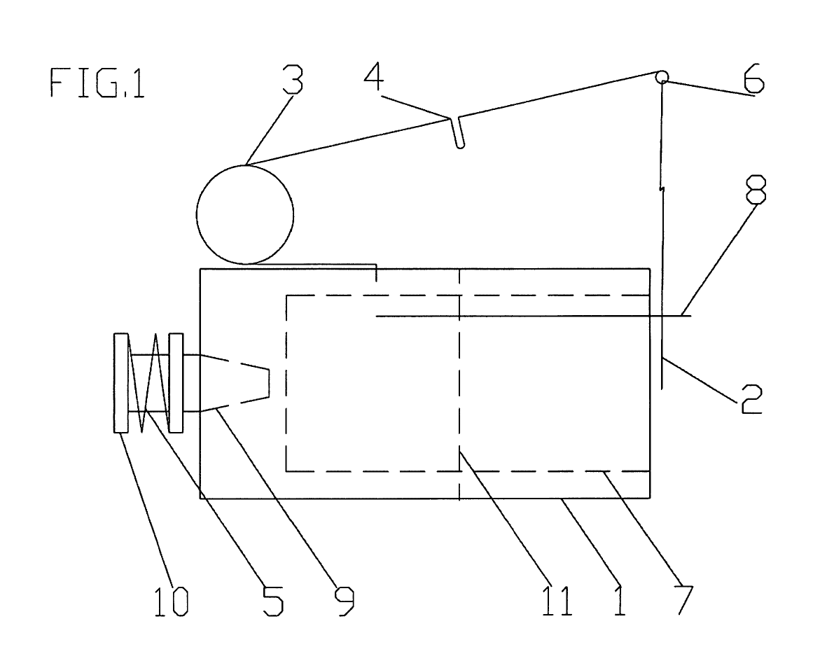

FIG. 2 is a side view of the present invention in the cocked position;

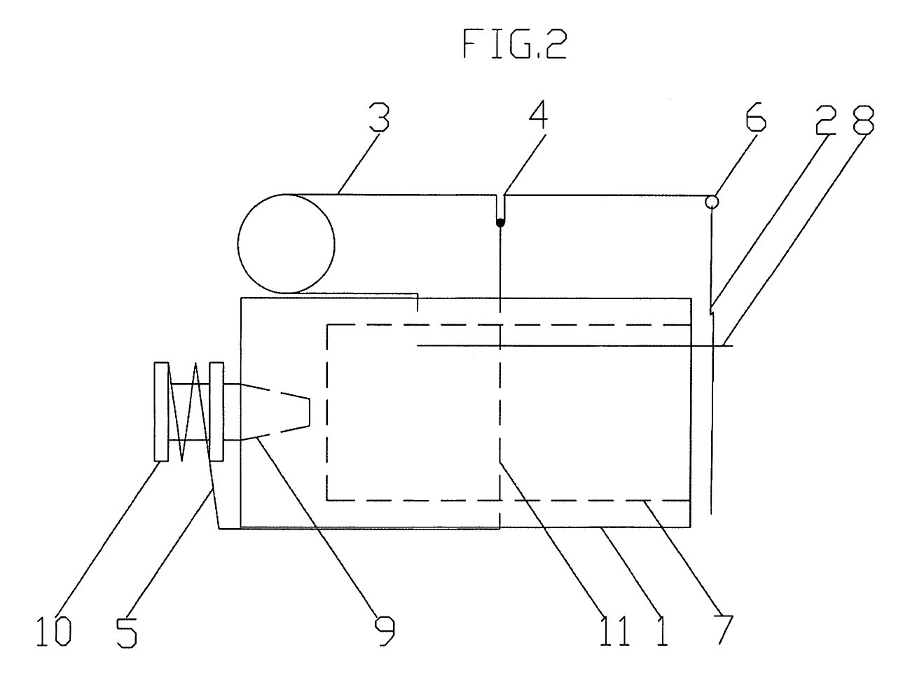

FIG. 3 is a bottom view of the present invention;

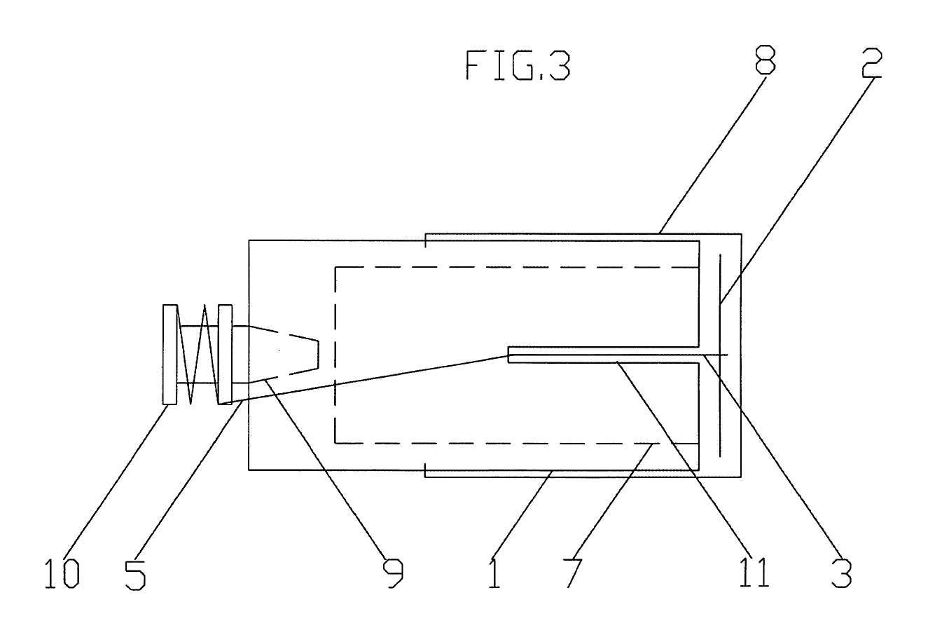

FIG. 4 is a front view of the present invention in the cocked position;

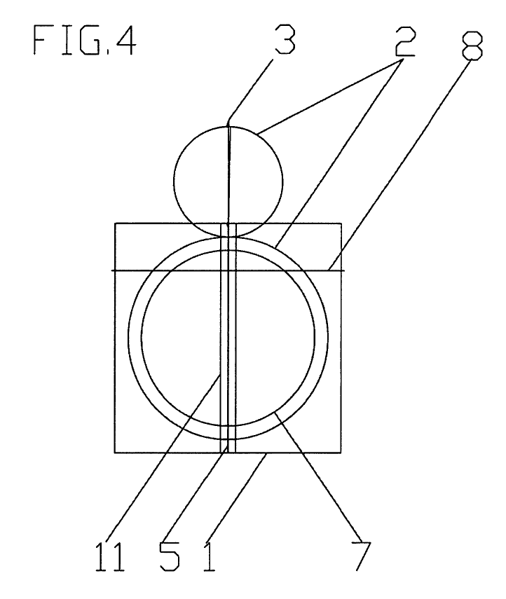

FIG. 5 is a front view of two assemblies of the present invention in the cocked position;

FIG. 6 is a three dimensional depiction of the assembly in a uncocked position

### DETAILED DESCRIPTION OF THE MOUSE TRAP

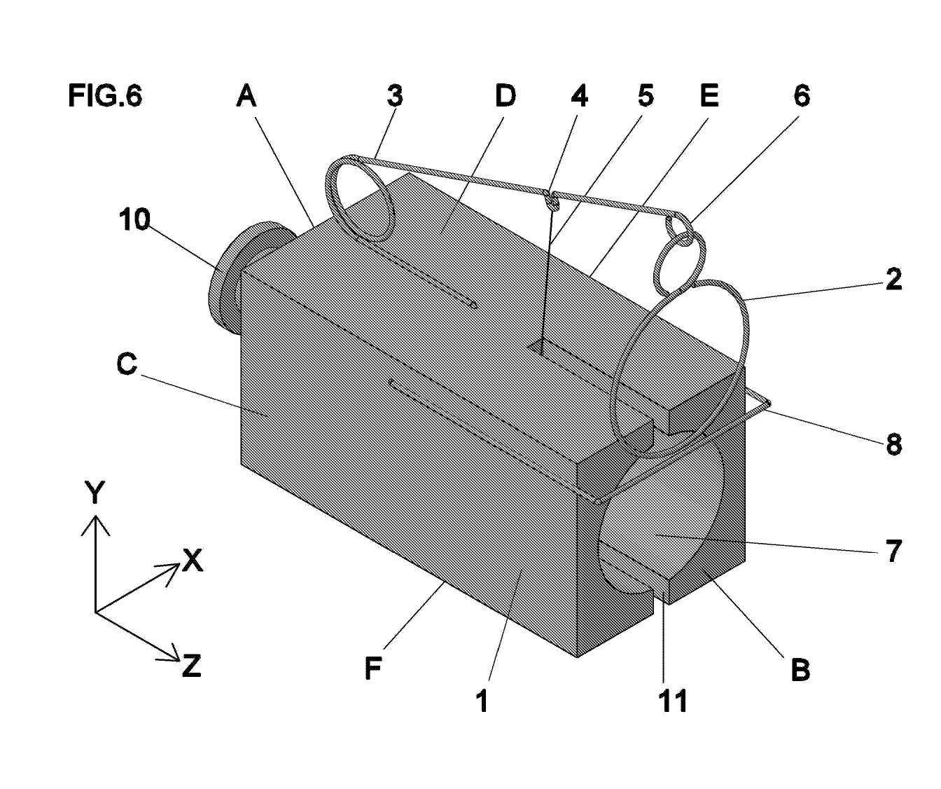

The trap consists of a prism-shaped main body (1); 8-shaped jaw membrane (2), see FIG. 6, made out of a single piece of metal wire and loosely attached to a J-shaped spring (3), also made out of a single piece of metal wire; threat (5) that connects the spring with the drum and the arrester that prevents the mouse from backing;

Main body represents a right square prism bearing a circular opening situated symmetrically in its base (B), which leads to a cylindrical hole (7). Said hole continues into the body longitudinally, three forth of the prism length along axel Z. Bait is set at the deep end of the hole (7). The wire that shapes the J-shaped spring is formed into a larger ring at its one end, forming the spring, as shown on FIG. 6. This ring is affixed firmly and symmetrically on top of the main body (1), aligned with the edge between base (A) and lateral face (D) of the prism; the spring wire is indented into a U-shaped hook (4) to match the transverse slot (11) on the main body (1), while the loose end of the spring wire is formed into a smaller ring (6). One end of the thread (5) is attached to the hook (4); the then thread runs through the transverse slot (11), preventing the mouse from reaching the bait; other end of the tread is rolled over drum (10). Said transverse slot (11) runs vertically across the main body passing at the center of the hole (7); the threat is stretched to provide firm grip to the spring when the device is in the charged position; the spring then released as a mouse crunches the thread loose; once released, the spring pulls the mouse upward (along axel Y), securing it against the top of the cylindrical hole (7) and arrester (8). Said arrester (8) made out of a single piece of metal wire, with its ends affixed firmly at the prism's opposite lateral faces (C) and (E) respectively, two thirds of the corresponding face's length counting from the base (B) along axel Z, and four fifths of the face's height counting from the lateral face (F) along the axel Y. The arrester runs along main body's perimeter and above the hole (7), when it crosses parallel to base (B) long axel X. Thus, the arrester resembles the prism in shape, and insures free movement of the 8-shaped membrane (2) along axel Y, while restricts the membrane's movement along axel Z. There is a quarter-inch gap between the arrester and base (B) of the prism to achieve this goal. Once the mouse is trapped, the arrester prevents the mouse from pulling backwards along axel Z. Said 8-shaped jaw membrane (2) is made out of a single steal wire, which is bended into the “8” shape, which consists of a smaller ring and a larger ring, while the smaller ring is loosely attached to the smaller ring-end (6) of the said J-shaped spring (3), the larger ring serves to pull and choke-noose the mouse as the mouse bites off said thread (5) setting loose the J-shaped spring (3). Said drum (10) is fixed inside the cone-shaped hole (9) at the base (A) of the prism. The drum is made of the same material as the main body with one end of it formed into a drum, while the other shaped into a cone to fit said cone-shaped hole (9) at the base (A) of the prism. The cone-shape hole insures sufficient friction to hold the drum in place, while at the same time allows for easy and effortless retraction of the drum when needed.

When the device is not armed the jaw membrane dangles loosely on the loose end of the spring, so that no pressure is applied to the spring. One end of the thread is tied in a knot and attached to the inner end of the U-shaped hook. To charge the device, the threat is stretched through the transverse slot (11) and rolled over the drum (10) compressing the spring and bringing it into a cocked position. Once charged, the mouse is ready to be caught.

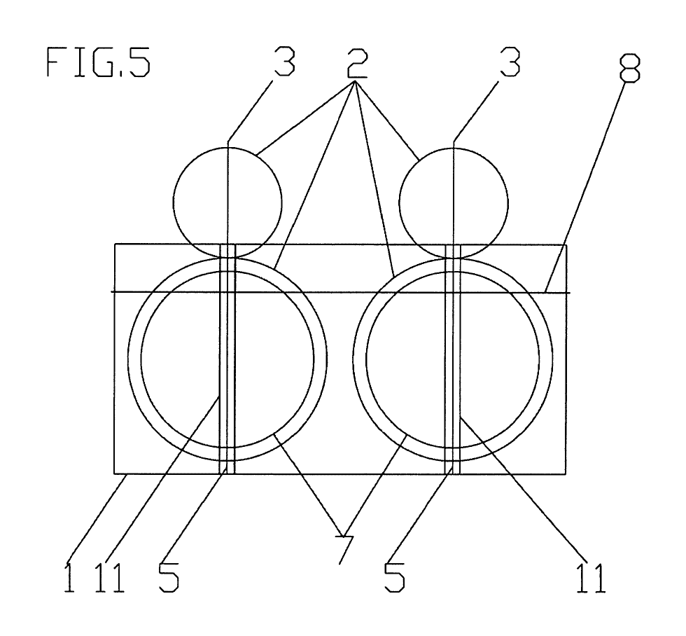

There can be one or several such assemblies (FIG. 5), depending on the desirable size of the device and the desired number of mice it shall accommodate.

1. A mouse-trap, which consists of a main body (1); 8-shaped jaw membrane (2), loosely attached to a J-shaped spring (3); which J-shaped spring is equal in length to the length of the main body, with one end the spring is formed into a loop and firmly affixed on top of the main body thus forming a spring, while other continues straight until it is indented into a U-shaped hook (4), to match the transverse slot (11) in the main body, and then continues straight again until it is formed into a smaller ring (6), to which said 8-shaped membrane (2) is attached; thread (5) inserted through a slot (11) in the main body (1), so that one end of the thread (5) is affixed to the U-shaped hook (4), while the other is rolled over a drum (10); drum (10) sits on the cone-shaped drum-base, firmly inserted into the corresponding cone-shaped hole (9), made at the base (A) of the main body; and the arrester (8) which resembles the shape of the main body, and whose ends firmly attached to the respective lateral faces (C) and (E).
(a) Said main body constitutes a solid right square prism made of any suitable material including wood, plastic or metal; bases of which (A and B) are square polyhedrons, while all four lateral faces (C, D, E and F) are right rectangular polyhedrons; base vertices which run along axel Y are the height of the prism; base edges, those that are parallel to axel X are the depth of the prism, while those that run along axel Z are the length of the prism; base (B) bears a circular opening leading to a cylindrical hole (7); the hole is situated symmetrically in the center of the prism; the hole runs as deep as three fourth of the length of the prism; transverse slot (11) cross-sections the prism long its height and runs through the center of the hole (7) along axel Y; the slot is as long as one half of the length of the hole along axel Z; the slot accommodates threat (5) when device is in charged position, so that the threat is stretched through slot (11) with one end of it firmly connected to the U-shaped hook (4), while the other is rolled over the drum (10); base A of the body also contains an opening, which runs into a cone-shaped hole (9); this hole is situated symmetrically at the center of the body and matches in length and shape said cone-shaped drum-base;
(b) Said J-shaped spring (3) is made of a single metal wire, and equal in length to the length of the main body; its one end is formed into a loop, forming the spring, and firmly and symmetrically affixed at the lateral face (D); it is aligned with the edge between base (A) and lateral face (D), which edge runs along axel X; the wire then is indented into a U-shaped hook (4) to match the transverse slot (11), while its loose end is formed into a smaller ring (6), to which said 8-shaped jaw membrane (2) is loosely attached;
(c) Said 8-shaped jaw membrane (2) is made out of a single metal wire, which is bended into the “8” shape, which consists of a smaller ring and a larger ring, while the smaller ring is loosely attached to the smaller ring (6) of the said spring (3), while the larger ring serves to pull and choke-noose the mouse as the mouse bites off said thread (5) setting the spring (3) loose; unleashed power of the spring pulls and holds the mouse securing it against the top of the hole (7) and arrester (8);
(d) Said arrester (8) is made of metal wire, with its corresponding ends firmly affixed at the opposite lateral faces (C) and (E) of the main body, two thirds of the corresponding face's length counting from the base (B) along axel Z, and four fifths of the face's height counting from the lateral face (F) along the axel Y, so that the arrester resembles the shape of the main body, as it runs along main body's perimeter and above the hole (7), when it crosses parallel to base (B) long axel X; there is a gap between the base (B) and the arrester, equal three times the diameter of the wire of which 8-shaped membrane is made;
(e) Said drum is made out of wood or any suitable material matching that of the said main body, so that its one end stores the thread while the other is narrowed into a cone-shape drum-base to fit the cone-shaped hole (9) in the main body (at the base (B)) of the prism).
A mouse-trap, which consists of a main body (1); 8-shaped jaw membrane (2), loosely attached to a J-shaped spring (3); which J-shaped spring is equal in length to the length of the main body, with one end the spring is formed into a loop and firmly affixed on top of the main body thus forming a spring, while other continues straight until it is indented into a U-shaped hook (4), to match the transverse slot (11) in the main body, and then continues straight again until it is formed into a smaller ring (6), to which said 8-shaped membrane (2) is attached; thread (5) inserted through a slot (11) in the main body (1), so that one end of the thread (5) is affixed to the U-shaped hook (4), while the other is rolled over a drum (10); drum (10) sits on the cone-shaped drum-base, firmly inserted into the corresponding cone-shaped hole (9), made at the base (A) of the main body; and the arrester (8) which resembles the shape of the main body, and whose ends firmly attached to the respective lateral faces (C) and (E);
(a) Said main body constitutes a solid right square prism made of any suitable material including wood, plastic or metal; bases of which (A and B) are square polyhedrons, while all four lateral faces (C, D, E and F) are right rectangular polyhedrons; base vertices which run along axel Y are the height of the prism; base edges, those that are parallel to axel X are the depth of the prism, while those that run along axel Z are the length of the prism; base (B) bears a circular opening leading to a cylindrical hole (7); the hole is situated symmetrically in the center of the prism; the hole runs as deep as three fourth of the length of the prism; transverse slot (11) cross-sections the prism long its height and runs through the center of the hole (7) along axel Y; the slot is as long as one half of the length of the hole along axel Z; the slot accommodates threat (5) when device is in charged position, so that the threat is stretched through slot (11) with one end of it firmly connected to the U-shaped hook (4), while the other is rolled over the drum (10); base A of the body also contains an opening, which runs into a cone-shaped hole (9); this hole is situated symmetrically at the center of the body and matches in length and shape said cone-shaped drum-base;
(b) Said J-shaped spring (3) is made of a single metal wire, and equal in length to the length of the main body; its one end is formed into a loop, forming the spring, and firmly and symmetrically affixed at the lateral face (D); it is aligned with the edge between base (A) and lateral face (D), which edge runs along axel X; the wire then is indented into a U-shaped hook (4) to match the transverse slot (11), while its loose end is formed into a smaller ring (6), to which said 8-shaped jaw membrane (2) is loosely attached;
(c) Said 8-shaped jaw membrane (2) is made out of a single metal wire, which is bended into the “8” shape, which consists of a smaller ring and a larger ring, while the smaller ring is loosely attached to the smaller ring (6) of the said spring (3), while the larger ring serves to pull and choke-noose the mouse as the mouse bites off said thread (5) setting the spring (3) loose; unleashed power of the spring pulls and holds the mouse securing it against the top of the hole (7) and arrester (8);
(d) Said arrester (8) is made of metal wire, with its corresponding ends firmly affixed at the opposite lateral faces (C) and (E) of the main body, two thirds of the corresponding face's length counting from the base (B) along axel Z, and four fifths of the face's height counting from the lateral face (F) along the axel Y, so that the arrester resembles the shape of the main body, as it runs along main body's perimeter and above the hole (7), when it crosses parallel to base (B) long axel X; there is a gap between the base (B) and the arrester, equal three times the diameter of the wire of which 8-shaped membrane is made;
(e) Said drum is made out of wood or any suitable material matching that of the main body, so that its one end stores the thread while the other is narrowed into a cone-shape drum-base to fit the cone-shaped hole (9) in the main body (at the base (B)) of the prism).
